(19) United States
(12) Patent Application Publication
(10) Pub. No.: US 2011/0184535 A1
(43) Pub. Date: Jul. 28, 2011

(54) Apparatus and Method for Simulating a Control Program

(75) Inventors: Richard FISCHER, Schwarzenbruck (DE); Stefan Schaan, Schwarzenbruck-Pfeifferhutte (DE)

(73) Assignee: Siemens AG, Munchen (DE)

(21) Appl. No.: 12/895,063

(22) Filed: Sep. 30, 2010

(30) Foreign Application Priority Data
Oct. 1, 2009 (EP) 09171952

(51) Int. Cl. G05B 9/00

(52) U.S. Cl. 700/21

(57) ABSTRACT

An apparatus for accessing a controller, wherein a first control program for controlling a process runs in the controller and the process is actively controlled by a process image of first input signals, which are received by the controller, and first output signals, which are output to the process by the controller. The apparatus comprises an interface for interchanging data with the controller and a computation unit for executing program code instructions of a second control program. The apparatus also includes a comparison device which is configured such that the first output signals can be compared with second output signals and provide a comparison result, where the second output signals can be generated by the second control program, the program code instructions of which differ from the program code instructions of the first control program.

### BACKGROUND OF THE INVENTION

1. Field of the Invention

The invention relates to an apparatus for accessing a controller, a first control program for controlling a process running in the controller and the process being actively controlled by a process image of first input signals, which are received by the controller, and first output signals which are output to the process by the controller, where the apparatus comprises an interface for interchanging data with the controller and a computation unit for executing program code instructions of a second control program and is also configured such that the process image of the first input signals can be supplied over the interface to the second control program as input variables.

The invention also relates to a method for simulating a control program which is intended to run in a controller for controlling a process.

2. Description of the Related Art

When controlling industrial processes, for example, using programmable logic controllers, there are only very restricted options for estimating the effects of modifications to control programs on the actual running of the programs or on the process during ongoing operation of processes or industrial installations. A modification to a control program thus involves a risk of undesirable responses or downtimes of the industrial installation being able to occur if a modified control program is loaded into the controller and controls the process. There is a great need to minimize this risk, in particular, in oil and gas or chemical industry installations or processes which are designed for continuous operation and a high degree of availability.

In conventional systems, it is a known practice to simulate a modified control program. Here, the process to be controlled or the installation is also simulated using a simulation. The aim of this type of simulation is to test a control program even before it runs in an pre-existing installation (offline). This type of simulation has the disadvantage in that the effects of the modification cannot be realistically simulated. As a result, the effects of the modification cannot be reliably assessed. Dynamic responses or changes in run times are also difficult to estimate. Consequently, a statement on the run behavior of the modified program in a pre-existing installation, which is intended to exhibit the same effects and entail the desired improvement, is not reliable.

EP 1 646 946 B1 discloses an apparatus for accessing a controller. This apparatus and an associated method make it possible to simplify the testing of a control program in a programmable logic controller. In this case, a programmable logic controller is loaded with a first control program and a computer system is loaded with a second control program which is identical to the first control program.

### SUMMARY OF THE INVENTION

It is an object of the present invention to improve a simulation and an apparatus for accessing a controller such that effects of a modification to a control program, as affect an actual process, can be pre-estimated in an improved manner.

This and other objects and advantages are achieved in accordance with the invention by comparison devices which are configured such that first output signals can be compared with second output signals to provide a comparison result, where the second output signals can be generated by the second control program, and the program code instructions of the second control program differ from the program code instructions of the first control program. In comparison with the known methods, different programs simultaneously run in a programmable logic controller and in a computation unit. Here, the first control program in the controller continuously controls a technical process. A second control program which has been modified, for example, based on optimization, runs in the computation unit. In order to test the modified control program before it is loaded into an active controller, the pre-existing process images of the first input signals are supplied to the computation unit. The first input signals are used as an input variable for the modified, second control program. A process image of the second output signals is then provided in the computation unit using the first input signals via the modified, second control program. A result from the second output signals may differ from the result from the first output signals because the control program has been modified. This difference can be detected using comparison devices. It is now possible to make a statement relating to whether the modifications to the second control program will exhibit the same effects and entail the desired improvements when the program runs in the actual installation. A risk of an incorrectly controlled process due to modifications to control programs can therefore be advantageously minimized.

In another embodiment of the invention, it is advantageous if the apparatus has output devices which inform a user of the comparison result. These output devices may be, for example, graphical representations on an operating screen or may be provided to an installation operator using a log.

It is also advantageous if the comparison devices are configured such that a statement relating to an extent to which the first output signals differ from the second output signals can be generated based on the comparison result. The extent of the difference could therefore be used to also automate a risk assessment for a modified control program using pre-definable maximum limits if, for example, for the maximum limits which should not be exceeded, tolerance values or tolerance ranges are predefined for output values from the process.

In another advantageous embodiment, the apparatus includes a device for controlling the interchange of data over the interface, where the interchange of data is controllable in a cycle-synchronous manner with respect to a run cycle of the first control program or based on an event. It is particularly important, in particular to control preferably real-time processes, to provide particular output signals at a certain time or in a certain time slot. Here, in order to also achieve a virtually realistic simulation, it is advantageous, for the simulation quality, to calculate the output signals simulated in the computation unit in a cycle-synchronous manner with respect to the run cycle of a controller, such as a programmable logic controller.

The apparatus can be optimized further if it is configured to load the second control program into the controller based on the comparison result. This “download” of the altered control program to the controller could be automated whilst observing the abovementioned limit values or tolerance values.

The object of the invention is likewise achieved by a method for simulating a control program which is intended to run in a controller for controlling a process, where a first control program for controlling the process runs in the controller and a process image of first input signals is received by the controller and a process image of first output signals is output to the process by the controller, and where the process is actively controlled thereby. Here, the method comprises the steps of

a) executing a second control program in a computation unit,

b) coupling the computation unit to the controller,

c) receiving the first input signals and the first output signals in the computation unit, where the first input signals are supplied to the second control program as input variables,

d) generating a process image of second output signals by program code instructions of the second control program, and

e) comparing the first output signals with the second output signals, where the second output signals are simulated by the second control program based on the first input signals.

Possible effects of a modification to the second control program based on the first control program can therefore be reliably assessed. Dynamic responses or changes in run times can therefore be estimated in an improved manner. A statement relating to whether the modification to the second control program based on the first control program would exhibit the same effects if the program were run in an actual installation can thus be improved.

A comparison result is provided in a next advantageous method step, and an extent to which the first output signals differ from the simulated second output signals is determined using the comparison result. The two process images, i.e., the first output signals and the second output signals, can be compared and evaluated after running through n cycles. If no difference or only the desired behavior is exhibited, the modified control program can be transmitted to a running system with a very low residual risk. Running systems are considered to be, in particular, systems for use in critical processes which are, in particular, fault-tolerant systems and fault-tolerant and highly available systems.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in more detail based on the exemplary embodiments illustrated in the figures, in which:

FIG. 1 is an exemplary illustration of an apparatus for accessing a controller for simulating a modified control program in accordance with the invention; and

FIG. 2 is a flow chart of a method in accordance with an embodiment of the invention.

### DETAILED DESCRIPTION OF THE PRESENTLY PREFERRED EMBODIMENTS

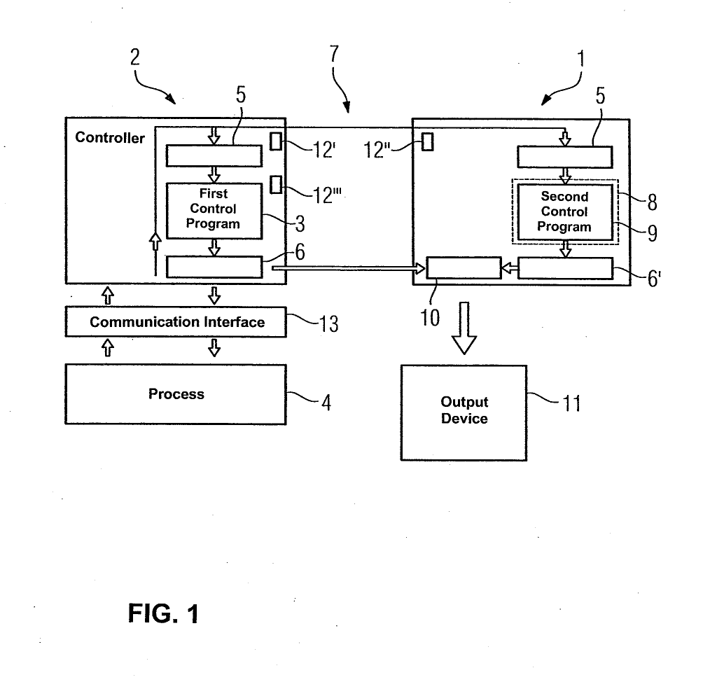

FIG. 1 is an illustration of an apparatus 1 for accessing a controller 2, where a first control program 3 for controlling a process 4 is running in the controller 2. The process 4, which is, for example, a process engineering industrial process for the chemical industry, is controlled using input and output signals. The controller 2 is provided with a process image of first input signals 5 of the process over a communication interface 13 which is arranged between the controller 2 and the process 4. The first input signals 5 are processed in the controller 2 by the first control program 3, and first output signals 6 are then provided. The first output signals 6 form a process image of output signals for the process 4. The first output signals 6 are in turn supplied to the process 4 over the communication interface 13. The altered first output signals may open or close valves in the process, for example, whereupon the behavior of the process changes and altered first input signals 5 are consequently again provided for the controller 2.

In order to simulate a modified, second control program 9, an apparatus 1 for accessing the controller 2 is configured with a computation unit 8. The second control program 9 is provided with the process image of the first input signals 5 as input variables over an interface 7. The second control program 9 can now run in the computation unit 8 and operates with the process image of the actual process as first input signals 5.

After the program code instructions of second control program 9 have been executed, the modified, second control program 9 provides a process image of second output signals 6′.

A comparison result is provided using a comparison device 10 which is configured such that the first output signals 6 can be compared with the second output signals 6′. A user is provided with this comparison result by an output device 11, such as a display screen or a log printer.

The comparison device 10 is also configured to generate an indication of an extent to which the first output signals 6 differ from the second output signals 6′ based on the comparison result.

The interface 7 is arranged between the controller 2 and the apparatus 1, which is used to couple the computation unit 8 to the controller 2, and also includes a device 12 for controlling the interchange of data between the controller 2 and the apparatus 1. Here, the controller 2 has a first communication module 12′ and the apparatus 1 has a second communication module 12″. These two communication modules 12′, 12″ are preferably connected to one another by an Ethernet line. These communication modules cooperate with a firmware memory 12″′. The firmware memory 12″′ is preferably arranged in the controller 2 and, as an additional component to standard firmware of the controller 2, controls the cyclical transfer of data from the running controller 2 to the apparatus 1 which, as a test system, preferably accepts the process image of the first input signals 5 from the controller 2 in a cycle-synchronous manner and supplies the image to the computation unit 8. In order to improve the performance of the communication link between the two communication modules 12′, 12″, data does not necessarily have to be transferred in a cycle-synchronous manner but rather communication may also be performed in an event-synchronous manner by the firmware memory 12″′.

If, for example, a service engineer has connected the apparatus 1 to the controller 2 to simulate his modified program in advance, he can transmit the modified control program 9 to the running installation with a low residual risk after analyzing a log which was provided using the output device 11. The invention presented here advantageously solves the problem of not being able to accurately estimate the effects on an installation/process when a control program is changed. A possibility of minimizing a residual risk is now provided, in which case a simulation system which is synchronized close to the process is provided for the purpose of minimizing the risk in the event of program changes.

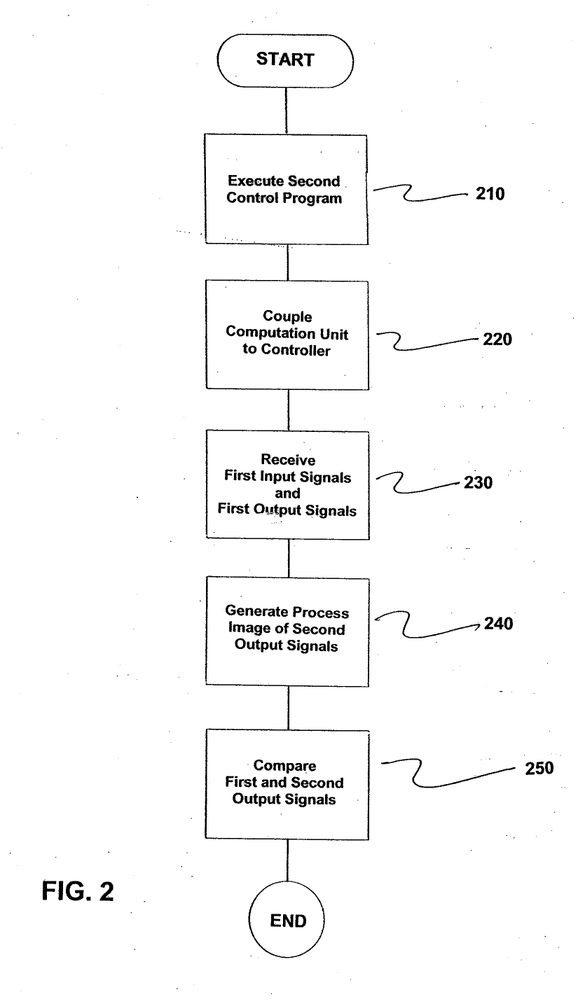

FIG. 2 is a flow chart of a method for simulating a control program which is intended to run in a controller for controlling a process. Here, a first control program for controlling the process runs in the controller and a process image of first input signals is received by the controller and a process image of first output signals is output to the process by the controller, where the process is actively controlled thereby. The method comprises executing a second control program in a computation unit, as indicated in step 210. Next, the computation unit is coupled to the controller, as indicated in step 220.

The first input signals and the first output signals are then received in the computation unit, as indicated in step 230. Here, the first input signals being supplied to the second control program as input variables. Next, a process image of second output signals is generated by program code instructions of the second control program, as indicated in step 240. The first output signals are then compared with the second output signals, as indicated in step 250. Here, the second output signals being simulated by the second control program based on the first input signals.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus for accessing a controller, a first control program for controlling a process running in the controller and the process being actively controlled by a process image of first input signals, which are received by the controller, and first output signals which are output to the process by the controller, said apparatus comprising:
an interface for interchanging data with the controller;
a computation unit for executing program code instructions of a second control program, the computation unit being configured to supply the process image of the first input signals over the interface to the second control program as input variables; and
a comparison device configured to compare the first output signals with second output signals and provide a comparison result, the second output signals being generated by the second control program using the process image of the first input signals, the second control program having program code instructions which differ from the program code instructions of the first control program.

2. The apparatus as claimed in claim 1, further comprising:
an output device which informs a user of the comparison result.

3. The apparatus as claimed in claim 1, wherein the comparison device is configured to generate an indication based on the comparison result relating to an extent to which the first output signals differ from the second output signals.

4. The apparatus as claimed in claim 1, further comprising:
a module for controlling an interchange of data over the interface, the interchange of data being controllable in one of a cycle-synchronous manner with respect to a run cycle of the first control program and an event-synchronous manner.

5. The apparatus as claimed in claim 1, wherein the apparatus is configured to load the second control program into the controller based on the comparison result.

6. A method for simulating a control program which is intended to run in a controller for controlling a process, comprising:
executing a first control program for controlling the process in the controller;
outputting, by the controller, a process image of first input signals being received by the controller and a process image of first output signals being output to the process by the controller;
executing a second control program in a computation unit;
coupling the computation unit to the controller;
receiving the first input signals and the first output signals in the computation unit, the first input signals being supplied to the second control program as input variables;
generating a process image of second output signals by program code instructions of the second control program; and
comparing the first output signals with the second output signals, the second output signals being simulated by the second control program based on the first input signals.

7. The method as claimed in claim 6, further comprising:
providing a comparison result; and
determining an extent to which the first output signals differ from the simulated second output signals using the comparison result.

8. The method as claimed in claim 7, further comprising:
performing a test to determine whether the extent to which the first output signals differ from the simulated second output signals is less than a pre-definable limit; and
deciding whether the second control program is suitable for running in the controller.

9. The method as claimed in claim 6, wherein the first input signals of the computation unit are provided in one of a cycle-synchronous manner and an event-synchronous manner.
